(19) United States
(12) Patent Application Publication
(10) Pub. No.: US 2026/0318453 A1
(43) Pub. Date: Oct. 15, 2026

(54) FLUID CONNECTION FLANGE

(71) Applicant: ARIANEGROUP SAS, Les Mureaux (FR)

(72) Inventor: Alain PYRE, Vernon Cedex (FR)

(73) Assignee: ARIANEGROUP SAS, Les Mureaux (FR)

(21) Appl. No.: 19/483,747

(22) PCT Filed: May 7, 2024
(86) PCT No.: PCT/FR2024/050607

§ 371 Date: Nov. 12, 2025

(30) Foreign Application Priority Data
May 12, 2023 (FR) FR2304748

(51) Int. Cl. F16L 23/036; B64G 1/00; F16L 23/18

(52) U.S. Cl. CPC F16L 23/036; F16L 23/18; B64G 1/008

(57) ABSTRACT

A fluid connection flange for rigidly and sealingly connecting a hydraulic member, including: a solid first wall forming a bearing surface intended to be applied against an attachment surface; a solid second wall provided facing the first wall; at least one solid, cylindrical spacer extending perpendicularly between the first and the second wall, forming a passage intended to allow a shank of an attachment member to pass therethrough; and a lacunary filling portion, extending between the first wall and the second wall, outside the spacers, wherein the first wall, the second wall, the at least one spacer and the filling portion are produced jointly and integrally by an additive manufacturing technique.

### TECHNICAL FIELD

The present disclosure relates to a fluid connection flange for rigidly and tightly connecting a hydraulic member such as a pipeline, tank, rotary machine or other hydraulic equipment.

A fluid connection flange of this type can be used, in particular, in the space or aeronautical industry, for example in a rocket engine or in the supply line of a space launcher. It can concern any type of fluid, gas or liquid, and in particular a propellant such as liquid hydrogen or liquid oxygen.

### PRIOR ART

In the space industry, and particularly in the field of space launchers, it is common practice to use propulsion systems based on at least one liquid propellant, in particular oxygen, hydrogen or methane, supplied at high pressure. Moreover, these propellants are generally highly dangerous, in particular because of the significant risk of ignition or explosion.

Such propulsion systems therefore require propellant supply lines that have a very high level of tightness. Traditionally, this tightness is provided by metal gaskets.

Moreover, these lines are subject to very high mechanical stresses, firstly due to the pressure of the fluid transported and, secondly, due to the environment and operation of the launcher. The fluid connection flanges on these lines are therefore subjected to both axial and transverse forces, but also to torsional and bending forces.

Consequently, known metal flanges are very thick and provided with a large number of bolts to enable them to withstand all these stresses while ensuring a sufficient level of compression of the metal gaskets. This, of course, implies a significant mass, which reduces the payload that the launcher can carry.

There is therefore a real need for a fluid connection flange enabling a hydraulic component to be rigidly and tightly connected, and which is at least partially free from the disadvantages inherent in the above-mentioned known configurations.

### DISCLOSURE OF THE INVENTION

The present disclosure relates to a fluid connection flange, comprising
a solid first wall forming a bearing surface intended to be applied against an attachment surface,
a solid second wall provided facing the first wall,
at least one solid, cylindrical spacer extending perpendicularly between the first and the second wall, forming a passage intended to allow a shank of an attachment member to pass therethrough, and
a lacunary filling portion, extending between the first wall and the second wall, outside the spacers,
wherein the first wall, the second wall, said at least one spacer and the filling portion are produced jointly and integrally by an additive manufacturing technique.

It is understood here that the filling portion is connected directly to the first and second walls and that it comprises lacunae, i.e. voids, preferably macroscopic voids, distributed throughout the filling portion. Such a structure, including at least one lacunary portion, enables the mass of the fluid connection flange to be substantially reduced, while maintaining tightness and sufficient mechanical strength.

In particular, the bearing surface intended to be applied against the fastening surface remains solid, as does the rear surface against which the heads of the fastening member will be tightened. The spacers, which rigidly connect the two walls, are provided at the fastening members to ensure that the flange can mechanically withstand the axial compression forces of the fastening members, thus preventing the flange from collapsing and releasing the compression forces that hold it firmly against the fastening surface. Similarly, when a gasket is fitted to the flange, it remains suitably compressed, maintaining a satisfactory level of tightness.

Moreover, this structure, like a sandwich panel, enables a high bending moment of inertia to be obtained, reducing the risk of deformation of the flange between the fastening members.

The filling portion is sufficient to maintain the distance between the first and the second wall in the least loaded areas of the flange.

The use of an additive manufacturing technique advantageously makes it very easy to produce such a hybrid structure in a single operation. This type of additive manufacturing technique also enables the flange to be produced directly with a geometry, which may be complex, as close as possible to its final geometry, drastically reducing the need for subsequent machining stages.

In some embodiments, the first wall is flat. This configuration is particularly suitable when the attachment surface against which the flange is applied is flat.

In some embodiments, the first wall is annular. This configuration is particularly suitable when the fluid connection interface is circular.

In some embodiments, the second wall is flat.

In some embodiments, the second wall is annular.

In some embodiments, the second wall is parallel to the first wall.

In some embodiments, the thickness of the second wall is between 50% and 200% of the thickness of the first wall, preferably substantially equal to the thickness of the first wall.

In some embodiments, the distance between the first wall and the second wall is constant. This distance is measured perpendicular to the first wall.

In some embodiments, the distance between the first wall and the second wall is at least 300%, preferably at least 500%, of the thickness of the first wall. The bending moment of inertia of the flange is thus increased.

In some embodiments, the flange comprises a plurality of spacers. One spacer is therefore preferably provided for each fastening member. They may be evenly spaced along the first wall, in particular in the circumferential direction when the flange is annular. They may be located on the same flange diameter when the flange is annular.

In some embodiments, the thickness of said at least one spacer is at least equal to the thickness of the first wall. It may, however, be strictly greater and, in particular, at least equal to 150% of the thickness of the first wall. This thickness enables the axial stresses imposed by the fastening members to be satisfactorily withstood.

In some embodiments, the lacuna ratio in the filling portion is at least 20%, preferably at least 50%, more preferably at least 80% or even at least 90%. The lacuna ratio is defined here as the ratio of the cumulative volume of voids included in the filling portion to the total volume occupied by the filling portion.

In some embodiments, the filling portion has a cellular, columnar or lattice structure. This structure may or may not be regular, in terms of the geometry and/or size of the lacunae.

In some embodiments, the filling portion occupies at least 50%, preferably at least 80%, more preferably at least 90%, of the volume defined between the first and second walls, outside each spacer. This thus helps to maintain the distance between the two walls throughout the flange.

In some embodiments, the flange comprises a notch formed in the bearing surface. Such a notch can be useful for fitting an accessory, for example a gasket, in the flange. Such a notch may be formed, in particular, by the local interruption of the first wall, for example at its inner end. The notch can also be partially formed by a recess in the filling portion.

In some embodiments, the flange comprises a gasket installed in said notch formed in the bearing surface. In particular, this may be an O-ring, or a gasket with a C-shaped or V-shaped cross-section, the latter providing greater elasticity and, therefore, ensuring a greater force to promote tightness when the interfaces move. This gasket can be made of stainless steel or Inconel.

In some embodiments, the flange comprises a solid reinforcing wall extending from the second wall towards the first wall, perpendicular to the second wall. This reinforcing wall enables the flange to be locally reinforced against axial forces, for example at a gasket located in said flange or facing it in the attachment surface. This reinforcing wall may extend to the first wall or be interrupted before reaching the latter.

In some embodiments, said reinforcing wall extends to said notch formed in the bearing surface. In such a case, the distal end of the reinforcing wall forms a portion of the bottom of the notch.

In some embodiments, the thickness of the reinforcing wall is at least 100%, preferably at least 200%, of the thickness of the first wall. This provides effective resistance to axial compression forces.

In some embodiments, the flange comprises, at least along one edge of the first wall, a solid closure wall extending from said edge of the first wall towards the second wall. Such a closure wall is particularly useful when a fluid is flowing along this edge, in order to at least partially mask the lacunary filling portion with a smooth surface to reduce the risk of disturbing the flow. This closure wall can extend to the edge of the second wall in order to completely mask the filling portion at this point, or can be interrupted before the second wall, in particular in the presence of a notch.

In some embodiments, a closure wall extends at least along the inner edge of the first wall.

In some embodiments, at least one dust removal hole is provided in the closure wall. Such a dust removal hole enables the unsolidified material corresponding to the lacunae in the filling portion to be removed after additive manufacturing.

In some embodiments, the filling portion opens out along the outer edge of the first wall. In other words, there is no closure wall along the outer edge. In the absence of fluid at this point, such a closure wall is superfluous: on the contrary, its absence makes it possible to reduce the mass and enables the dust to be removed from the filling portion at the end of additive manufacturing.

In some embodiments, the flange comprises a solid working wall extending from the second wall, opposite the first wall. This wall may, for example, be the peripheral wall of a pipe or the casing of a hydraulic device.

In some embodiments, the working wall extends perpendicular to the second wall.

In some embodiments, the working wall extends from an edge of the second wall, preferably from its inner edge.

In some embodiments, the working wall is cylindrical.

In some embodiments, the thickness of the first wall is between 50% and 100%, preferably between 60 and 80%, of the thickness of the working wall.

In some embodiments, the flange comprises a solid transition wall extending obliquely between the second wall and the working wall. This then facilitates the transmission of forces at the interface between the working wall and the flange, which reduces the phenomenon of stress concentration at this interface.

In some embodiments, the thickness of the transition wall is between 50% and 100% of the thickness of the working wall.

In some embodiments, the angle formed between the transition wall and the second wall is between 30° and 60°, preferably between 40° and 50°. Such angles facilitate the transmission of forces.

In some embodiments, a second filling portion is provided in the volume defined between the working wall, the transition wall and the second wall. This configuration ensures good mechanical strength while limiting the mass of the assembly: indeed, the solid working wall and transition wall are sufficient to ensure satisfactory transmission of forces.

In some embodiments, this second filling portion occupies at least 50%, preferably at least 80%, even more preferably at least 90%, of the volume defined between the working wall, the transition wall and the second wall.

In some embodiments, at least one dust removal hole is provided in the transition wall.

In some embodiments, the flange is made of metal, preferably selected from the group consisting of nickel-based alloys, aluminium-based alloys, titanium-based alloys and steels. In particular, the housing can be made of Inconel, in particular Inconel 625 or Inconel 718 (registered trademarks).

Within the meaning of the present disclosure, an alloy is considered to be based on a given element when this element is the main element in the composition of this alloy, advantageously when this element is present in a higher content than the other components, even more advantageously in a content of at least 50% in molar percentage, even more advantageously of at least 60% in molar percentage.

The present disclosure also relates to a mechanical part, comprising a fluid connection flange according to any of the preceding embodiments. This could be a pipe, a tank, a pump, a turbine, an exchanger, a combustion chamber or any other hydraulic equipment.

The above mentioned features and advantages, and others, will become apparent on reading the detailed description which follows, of exemplary embodiments of the proposed fluid connection flange. This detailed description refers to the attached drawings.

### BRIEF DESCRIPTION OF THE DRAWINGS

The attached drawings are schematic and primarily aim to illustrate the principles of the disclosure.

FIG. 1 is an axial cross-sectional view of two pipes connected to each other using fluid connection flanges.

FIG. 2 shows a view of a fluid connection flange along plane B-B of FIG. 1.

### DESCRIPTION OF THE EMBODIMENTS

In order to make the disclosure more concrete, an example of a fluid connection flange is described in detail below, with reference to the attached drawings. It is recalled that the invention is not limited to this example.

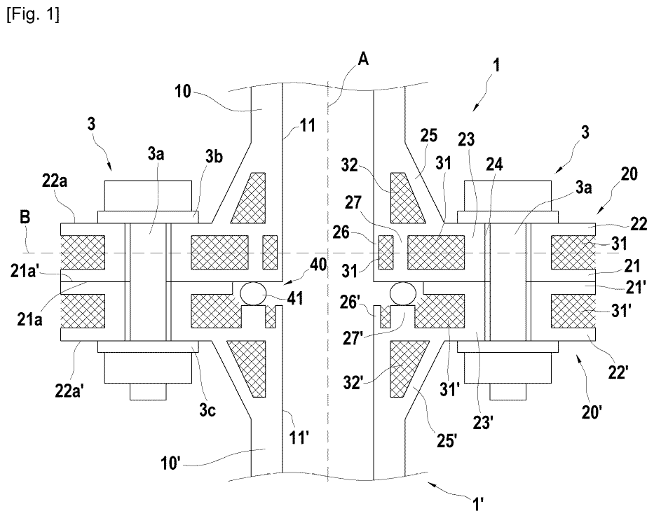

FIG. 1 shows a cross-section along a plane passing through their main axis A, showing a first pipe 1 and a second pipe 1′ assembled, one in the continuation of the other, so as to ensure continuity of their flow.

These pipes 1 and 1′ may, in particular, be the pipes of a rocket engine propellant supply line. In this respect, the fluid circulating in these pipes 1 and 1′ may in particular be a cryogenic propellant, such as liquid hydrogen or liquid oxygen. In one example, this fluid may have a temperature of around 20K and a pressure of around 200 to 300 bar.

Each pipe 1, 1′ comprises a cylindrical peripheral wall 10, 10′ defining a duct 11, 11′ for the fluid, and a fluid connection flange 20, 20′ enabling the pipes 1, 1′ to be connected mechanically and fluidically such that the ducts 11, 11′ are continuous with each other while ensuring that the flow is tight at the interface between the flanges 20, 20′.

Each fluid connection flange 20 comprises a first wall 21 and a second wall 22, which are flat, parallel and facing each other. They extend radially with respect to the main axis A, i.e. perpendicularly with respect to the peripheral wall 10 of the pipe 1, which can also be considered as a working wall of the flange 10 for the purposes of this disclosure. The second wall 22 therefore extends radially outwards from the end of the peripheral wall 10.

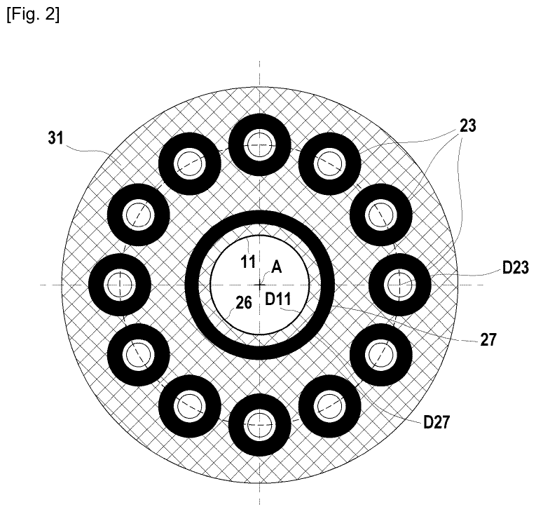

Each fluid connection flange 20 also comprises a plurality of cylindrical spacers 23 extending axially between the first wall 21 and the second wall 22, rigidly connecting them together. Each spacer 23 forms a cylindrical passage 24 opening onto the surface of the first wall 21 and the second wall 22 so as to enable the shank 3a of a connection member 3 to pass therethrough. As can be seen in FIG. 2, the spacers 23 are evenly distributed over a diameter D23 of the flange 20 centred around the main axis A.

The first wall 21 forms a bearing surface 21a intended to be applied against an attachment surface, in this case the bearing surface 21a′ of the fluid connection flange 20′ of the opposite pipe 1′. The bearing surfaces 21a, 21a′ of the fluid connection flanges 20, 20′ of each pipe 1, 1′ are thus fitted against each other and connection members, in this case bolts 3, are inserted into the passages 24 of the spacers 23 so as to hold the flanges 20, 20′ one against the other, the head 3b of the shank 3a and the nut 3c of each bolt 3 bearing against the seating surface 22a, 22a′ formed by the second wall 22, 22′ of each flange 20, 20′, in line with the spacers 23, 23′.

Each fluid connection flange 20 also comprises a transition wall 25 extending obliquely between the second wall 22 and the peripheral wall 10; therefore, as a whole, this transition wall 25 is frustoconical.

The fluid connection flange 20 of the first pipe 1, i.e. the upper pipe in FIG. 1, also comprises an axial cylindrical closure wall 26 extending between the first wall 21 and the second wall 22 in the continuation of the peripheral wall 10, thus continuing the duct 11 without a break.

The fluid connection flange 20 of the first pipe 1, i.e. the upper pipe in FIG. 1, also comprises an axial cylindrical reinforcing wall 27 extending between the first wall 21 and the second wall 22 concentrically with the axis A. This reinforcing wall 27 extends along a diameter D27 between the diameter D11 of the duct 11 and the diameter D23 of the spacers 23. The function of this reinforcing wall 27 will be explained below.

All the walls mentioned above (peripheral wall 10, first wall 21, second wall 22, spacers 23, transition wall 25, closure wall 26 and reinforcing wall 27) are solid and made of metal, preferably stainless steel, Inconel, titanium alloy or aluminium alloy.

Conversely, all the volumes between the first wall 21 and the second wall 22 not occupied by the axial walls mentioned above, and with the exception of the volumes corresponding to the passages 24 of the spacers, are occupied by a lacunary filling material. These various volumes, forming as many filling portions 31, are thus occupied by a lattice structure with a lacuna ratio of at least 50%, being equal to 90% in this example.

Similarly, the volume located between the peripheral wall 10, the second wall 22 and the transition wall 25 forms another filling portion 32 occupied by the same lacunary filling material.

The filling portions 31, 32 are made of the same material as the solid walls of the fluid connection flange 20. More specifically, all the solid walls mentioned 11, 21, 22, 23, 25, 26, 27, as well as the filling potions 31, 32, are produced simultaneously during the same additive manufacturing step.

The fluid connection flange 20′ of the second pipe 1′, i.e. the lower pipe in FIG. 1, is entirely identical to that of the first pipe 1, except that it comprises a notch 40 in which an O-ring 41 is installed, the latter being metallic in this case.

The structure of the flange 20′ of the second pipe 1′ is therefore identical to that of the flange 20 of the first pipe 1, except that the first wall 21′ does not extend to the duct 11′ and that the closure wall 26′ and the reinforcing wall 27′ do not extend to the first wall 21′, so as to form the notch 40. Similarly, the volume of the notch 40 is excluded from the filling portion 31′.

As can be seen in FIG. 1, the gasket 41 is positioned at diameter D27, i.e. at the position of reinforcing wall 27′, the distal end of the latter being in contact with the gasket 41. Thus, when the flanges 20, 20′ are assembled one against the other, the gasket 41 is compressed between the reinforcing wall 27′ of the flange 20′ of the lower pipe 1′ and the bearing surface 21a of the flange 20 of the upper pipe 1, in line with the reinforcing wall 27 of the latter.

Although the present invention has been described by referring to specific exemplary embodiments, it is obvious that modifications and changes can be made to these examples without going beyond the general scope of the invention as defined by the claims. In particular, the individual features of different embodiments illustrated or mentioned can be combined in additional embodiments. Consequently, the description and the drawings should be considered as illustrating rather than limiting.

It is also obvious that all the features described in reference to a method can be transposed, alone or in combination, to a device, and inversely, all the features described in reference to a device can be transposed, alone or in combination, to a method.

1. A fluid connection flange, comprising
a solid first wall forming a bearing surface intended to be applied against an attachment surface,
a solid second wall provided facing the first wall,
at least one solid cylindrical spacer extending perpendicularly between the first and the second wall, forming a passage intended to allow a shank of an attachment member to pass therethrough, and
a lacunary filling portion, extending between the first wall and the second wall, outside the spacers,
wherein the first wall, the second wall, said at least one spacer and the filling portion are produced jointly and integrally by an additive manufacturing technique.

2. The fluid connection flange according to claim 1, wherein the distance between the first wall and the second wall is constant, and
wherein the distance between the first wall and the second wall at least 300%, preferably at least 500%, of the thickness of the first wall.

3. The fluid connection flange according to claim 1, wherein the filling portion has a cellular, columnar or lattice structure.

4. The fluid connection flange according to claim 1, wherein the filling portion occupies at least 50%, preferably at least 80%, more preferably at least 90%, of the volume defined between the first and second walls, outside each spacer.

5. The fluid connection flange according to claim 1, comprising a notch formed in the bearing surface, and
comprising a seal installed in said notch formed in the bearing surface.

6. The fluid connection flange according to claim 5, comprising a solid reinforcing wall extending from the second wall towards the first wall perpendicularly to the second wall, and
wherein said reinforcing wall extends to said notch formed in the bearing surface.

7. The fluid connection flange according to claim 1, comprising, at least along one edge of the first wall, solid closure wall extending from said edge of the first wall towards the second wall.

8. The fluid connection flange according to claim 1, wherein the filling portion opens out along the outer edge of the first wall.

9. The fluid connection flange according to claim 1, comprising a solid working wall extending perpendicularly from an inner edge of the second wall, opposite the first wall.

10. The fluid connection flange according to claim 9, comprising a solid transition wall extending obliquely between the second wall and the working wall,
wherein a second filling portion is provided in the volume defined between the working wall, the transition wall and the second wall.

11. The fluid connection flange according to claim 1, wherein the flange is made of metal, preferably selected from the group consisting of nickel-based alloys, aluminium-based alloys, titanium-based alloys and steels.

12. mechanical part comprising a fluid connection flange according to claim 1.
